(19) United States
(12) Patent Application Publication
(10) Pub. No.: US 2008/0193258 A1
(43) Pub. Date: Aug. 14, 2008

(54) Device To Be Fixed In A Support-Member Recess Configured In A Support Member

(75) Inventors: Jean-Jacques Legat, Grenoble (FR); Jerome Blanc, Saint Martin le Vinoux (FR)

Correspondence Address: BAKER & DANIELS LLP;111 E. WAYNE STREET, SUITE 800, FORT WAYNE, IN, 46802, US

(73) Assignee: A. RAYMOND ET CIE, Grenoble (FR)

(21) Appl. No.: 11/816,001

(22) PCT Filed: Jan. 26, 2006
(86) PCT No.: PCT/EP06/00662

§ 371 Date: Aug. 10, 2007

(30) Foreign Application Priority Data
Feb. 14, 2005 (DE) 102005006750.6

(51) Int. Cl. F16B 19/10

(52) U.S. Cl. 411/508

(57) ABSTRACT

A device to be fixed in a recess (19) configured in a support member (20) comprises an outer part (1) made of a soft material and insertable into the support-member recess (19), an inner part (4) made of a hard elastic material and able to be brought inwardly into engagement with the outer part (1) by means of a retaining arrangement (15), and an insertion part (6) that can be inserted in the inner part (4) from an insertion side (21), is configured to be more rigid than the inner part (4), and when inserted expands both the outer part (1) and the inner part (4). The outer part (1) has a pot-like configuration, with a circumferentially closed outer wall portion (2) and a base portion (3) that seals the outer part (1) at a rear face disposed opposite the insertion side (21) and is peripherally connected to the wall portion (2). The support-member recess is thereby sealed reliably even under relatively extreme external conditions.

### BACKGROUND OF THE INVENTION

1. Field of the Invention

The invention relates to a device by means of which a support member recess configured in a support member can be reliably sealed.

2. Description of the Related Art

Such a device is known from DE 42 08 125 A1. In that device, an outer part is made from a soft material and implemented as a coating for a circumferentially closed inner part made of a hard elastic material. A retaining arrangement to conjoin the outer part and the inner part is formed as a circumferential, radially outwardly projecting excrescence of the inner part. The insertion part is implemented as a screw which, on being screwed into the inner part, expands the arrangement of outer and inner parts, squeezing the outer part against the edge of the support-member recess. The inner part has a through-passing recess for the screw, and the outer part embraces the inner part only on its outer side facing the edge of the support-member recess, and does not seal it axially.

GB 1 245 868 A discloses a device to be fixed in a support-member recess configured in a support member, comprising an inner part, made of a hard elastic material, that is provided with a number of spaced-apart expansion leaves and can be inserted in a circumferentially closed outer part made of a soft material. The insertion part is implemented either as a screw or as a smooth-walled, cylindrical pin, which is displaced in the longitudinal direction to effect the expansion of the outer part and the inner part.

Known from DE 42 08 125 A1 is a device comprising an outer part made of a soft material and insertable in a support-member recess, and an inner part that is made of hard elastic material and is able to be brought inwardly into engagement with the outer part by means of a retaining arrangement. The outer part is implemented as an elastomeric coating that surrounds the inner part in the region of contact with the support-member recess. The prior device is further provided with an insertion part, configured as a screw, that is insertable into the inner part from an insertion side, is made to be more rigid than the inner part, and when inserted expands the outer part and the inner part, so the device can be connected to a stress-sensitive support member in a largely stress-free manner while the outer part undergoes squeezing, shape-changing deformation.

### SUMMARY OF THE INVENTION

The object underlying the invention is to specify a device by means of which a support-member recess configured in a support member can be sealed reliably, with secure retention and with simple construction and assembly of the device, with high sealing action even under relatively extreme external conditions.

This object is achieved according to the invention, in a device as described hereinbelow.

By virtue of the fact that the inventive device comprises an outer part having a pot-like configuration and an inner part provided with pin pieces that engage in depressions of the outer part that are configured between projections, undercut recesses being present that cooperate with an engaging structure on the projections in the region of the base portion and at the free ends of the pin pieces, the inventive device, after being inserted into the inner part, grasps the outer part by the edge of the support-member recess. The inner part is simultaneously secured in the outer part without any need for elaborate mounting manipulations.

Further suitable configurations of the invention are the subject matter of the dependent claims.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a side view of an exemplary embodiment of a device according to the invention, comprising an outer part, an inner part and an insertion part;

FIG. 2 is a perspective view of the outer part in the exemplary embodiment according to FIG. 1;

FIG. 3 is a perspective view of the inner part in the exemplary embodiment according to FIG. 1;

FIG. 4 is a cross section of the exemplary embodiment according to FIG. 1, with the outer part according to FIG. 2 inserted in a support-member recess of a support member, the inner part according to FIG. 3 inserted in the outer part, and the insertion part poised in an initial position on an insertion side;

FIG. 5 shows the arrangement according to FIG. 4 with the insertion part in an intermediate position during insertion into the inner part; and

FIG. 6 shows the arrangement according to FIG. 4 with the insertion part in an end position after insertion into the inner part.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

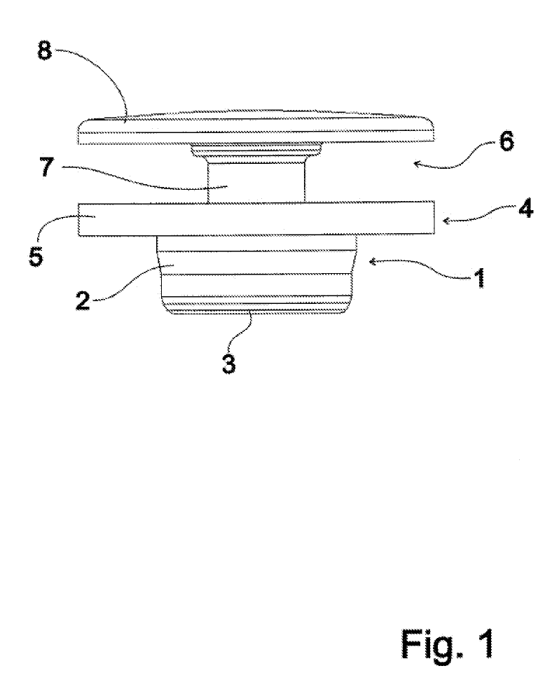

FIG. 1 is a side view of an exemplary embodiment of a device according to the invention, comprising an outer part 1 that has a pot-like configuration and is made of a soft material that is elastic and/or elastically deformable. In the exemplary embodiment shown, the outer part 1 comprises a substantially cylindrical lateral wall portion 2 and a base portion 3 peripherally connected to said wall portion 2.

The exemplary embodiment according to FIG. 1 is further provided with a hard elastic inner part 4, which in the arrangement according to FIG. 1 is inserted in outer part 1 and which can be seen in this arrangement to comprise a, for example circular, end disk 5 that projects laterally beyond the wall portion 2 of outer part 1.

The inventive device further comprises an insertion part 6 that is made to be more rigid than inner part 4, and which in the exemplary embodiment shown comprises a substantially cylindrical shank 7 and, formed onto one end of said shank 7, a flat cover plate 8 that preferably has the same outer dimensions as the end disk 5.

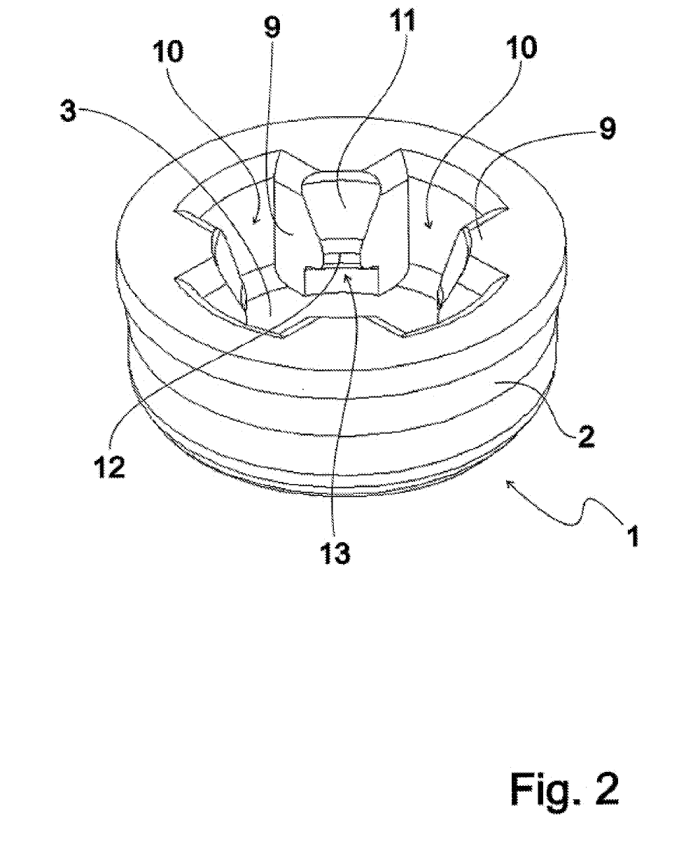

FIG. 2 is a perspective view of the outer part 1 of the inventive device according to FIG. 1. It is apparent from FIG. 2 that the wall portion 2 is configured with a number of regularly spaced, radially inwardly directed projections 9 and with pin-receiving depressions 10 arranged between said projections 9. Each of said projections 9 is provided on its side facing away from wall portion 3 with a radially outwardly beveled abutting face 11, an axially inwardly disposed vertex region 12, and, configured between said vertex region 12 and base portion 3, an undercut recess 13 that extends radially outward away from said vertex region 12.

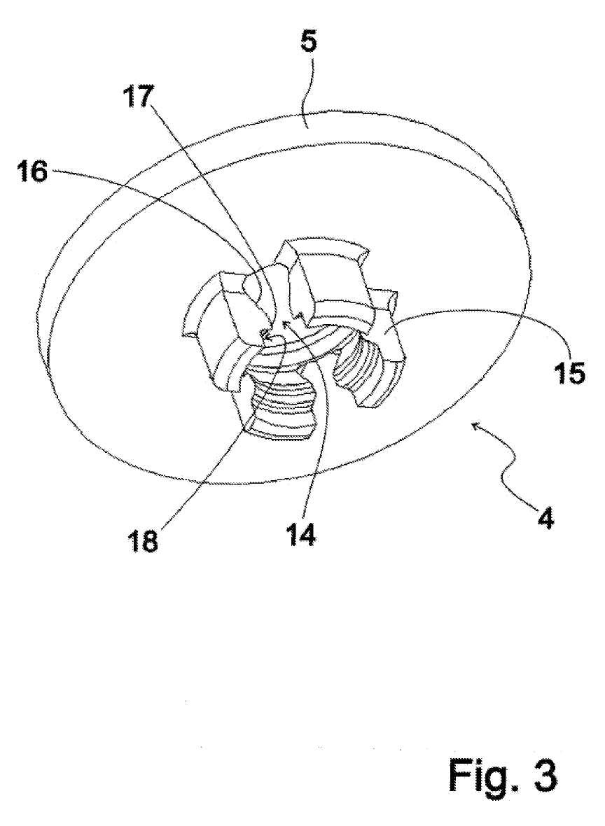

FIG. 3 is a perspective view of the inner part 4 of the exemplary embodiment according to FIG. 1. It is apparent from FIG. 3 that the end disk 5 is configured with a central shank recess 14 whose outer dimensions are adapted to the shank 7 of insertion part 6. Disposed on the inner edge of end disk 5 adjacent the shank recess 14 are a number of pin pieces 15 of a retaining arrangement, with the number of said pin pieces 15 and their relative positions corresponding to the positions of the pin-receiving depressions 10. The pin pieces 15 are configured, correspondingly to the projections 9, with beveled abutting faces 16, vertex regions 17 and projection recesses 18, such that after inner part 4 is inserted in outer part 1, the vertex regions 12, 17 form a circumferential annular bulge and the undercut recesses 13, 18 constitute an annular groove. The smallest inner diameter of said annular bulge is smaller than the outer diameter of the shank 7 of insertion part 6.

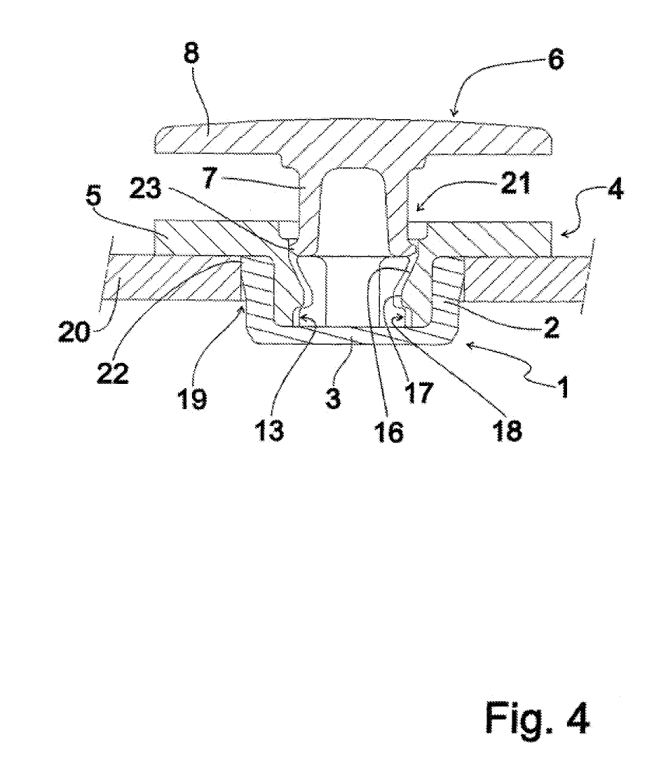

FIG. 4 is a cross section of the exemplary embodiment according to FIG. 1, with the outer part 1 according to FIG. 2 inserted in a support-member recess 19 of a support member 20, the inner part 4 according to FIG. 3 inserted in the outer part 1, and the insertion part 6 poised in an initial position on an insertion side 21. It is apparent from FIG. 4 that an annular collar 22 configured on the outer face of wall portion 2 of inner part 1 rests circumferentially against the inner face of support-member recess 19. It can further be appreciated from FIG. 4 that when the inventive device is arranged as intended, end disk 5 rests on support member 20 with its flat side facing outer part 1. Finally, it is depicted in FIG. 4 that the shank 7 is configured as hollowly cylindrical and that formed onto its end facing away from cover plate 8 is a circumferential, radially outwardly projecting snap ring 23.

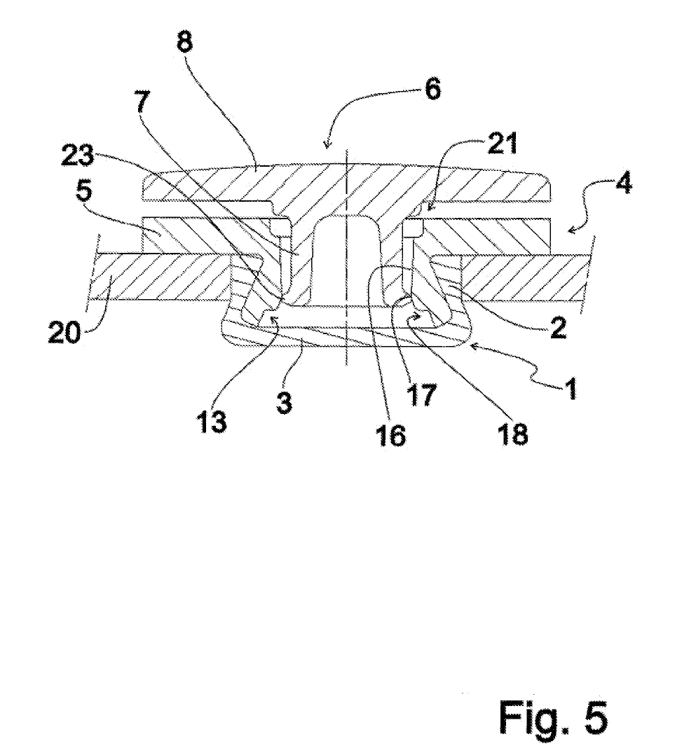

FIG. 5 shows the arrangement according to FIG. 4 with insertion part 6 inserted in inner part 4 in an intermediate position. It can be appreciated from FIG. 5 that snap ring 23, on passing over the abutting faces 11, 16 and the vertex regions 12, 17 of projections 9 and pin pieces 15, respectively, bends the projections 9 of outer part 1 and the pin pieces 15 of inner part 4 outward. Outer part 1 is thereby expanded radially outward and clamped, with wall portion 2 pressing against the inner edge of support-member recess 19.

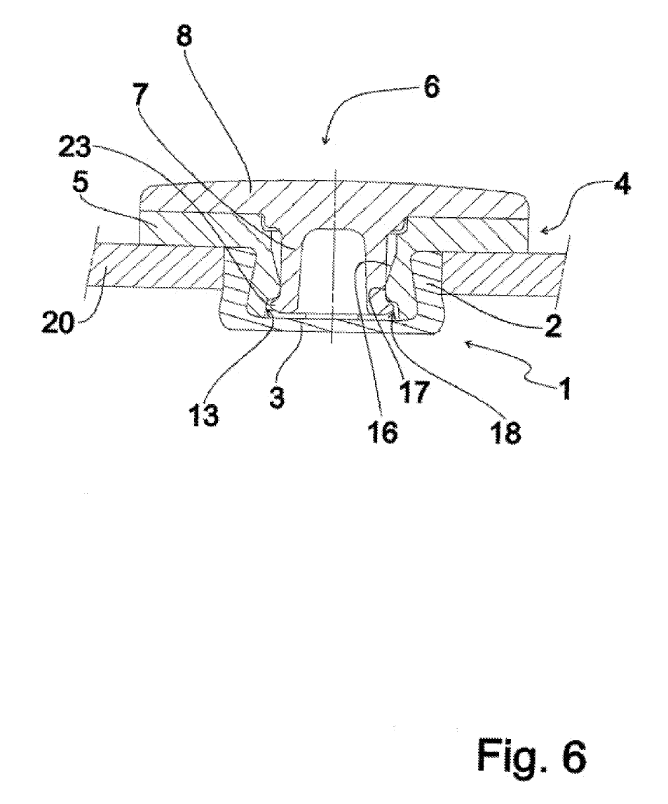

FIG. 6 shows the arrangement according to FIG. 4 with the insertion part 6, after insertion into inner part 4, in an end position in which the cover plate 8 of insertion part 6 rests on the end disk 5 of inner part 4. In this end position, when snap ring 23 is arranged in the annular groove 24 formed by the undercut recesses 13, 18, the pin pieces 15 of inner part 4 are bent slightly outward under bias from their resting position depicted in FIGS. 3 and 4, while wall portion 2 of outer part 1 remains expanded outward, compared to the position depicted in FIGS. 1, 2 and 4, in its region protruding from support member 20, and in its region disposed inside support-member recess 19 is pressed against the inner edge of support-member recess 19. This produces a force- and form-locking anchorage of outer part 1 and thus of the inventive device as a whole.

In this way, when outer part 1, inner part 4 and insertion part 6 of the inventive device are arranged as intended, support-member recess 19 is sealed reliably even under high pressures of up to approximately 100 bars and high temperatures of up to approximately 80 degrees Celsius, due to the fact that in addition to a first protection constituted by the end disk 5 of inner part 4 and the cover plate 8 of insertion part 6, inner part 4 and insertion part 6 are completely surrounded by outer part 1 in the region facing away from insertion side 21.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-4. (canceled)

5. A device to be fixed in a support-member recess (19) configured in a support member (20), said device comprising an outer part (1) made of a soft elastically deformable material and insertable into a said support-member recess (19), an inner part (4) made of a hard elastic material and adapted for being brought inwardly into engagement with said outer part (1) by means of a retaining arrangement (15), an insertion part (6) insertable into said inner part (4) from an insertion side (21), said insertion part (6) being more rigid than said inner part (4), and, when inserted, adapted to expand both said outer part (1) and said inner part (4), said outer part (1) having a pot-like configuration, with a circumferentially closed outer wall portion (2), a base portion (3), said base portion (3) joined circumferentially to said wall portion (2) and adapted to seal said outer part (1) at a rear face disposed opposite said insertion side (21), said outer part (1) comprising a plurality of inwardly extending projections (9) between which depressions (10) are configured, said inner part (4) compressing an end disk (5) that projects circumferentially beyond said circumferential wall portion (2), and a plurality of pin pieces (15) that are appended in the region of a shank recess (14) provided in said end disk (5), said pin pieces extending away from said end disk (5), an undercut recess (18), configured on each of said projections (9) in the region of said base portion (3), an undercut recess (13) configured at the free end of each of said pin pieces (15), said undercuts (13, 18) extending in the direction of said wall portion (2), said insertion part (6) comprising a shank (7) including an engaging structure (23) at the free end of said shank (7), said engaging structure (23) insertable into said undercut recesses (13, 18).

6. The device of claim 5, wherein said undercut recesses (13, 18) form a circumferential annular groove (24).

7. The device of claim 6, wherein said engaging structure is a snap ring (23).

8. The device of claim 5, wherein said outer part (1) comprises an annular collar (22) which projects radially beyond said wall portion (2).
